(19) United States
(12) Patent Application Publication
(10) Pub. No.: US 2025/0333339 A1
(43) Pub. Date: Oct. 30, 2025

(54) SYSTEM AND METHOD FOR PURIFYING WATER

(71) Applicant: NUOVO PIGNONE TECNOLOGIE SRL, Florence (IT)

(72) Inventors: Rajesh Srinivasan, Bangalore (IT); Simone Amidei, Sesto Fiorentino (IT); Uday Meduri, Bangalore (IT); Ajay Gaonkar, Bangalore (IN)

(21) Appl. No.: 18/651,110

(22) Filed: Apr. 30, 2024

(51) Int. Cl. C02F 1/68; C02F 103/08; G21F 9/06

(52) U.S. Cl. CPC C02F 1/685; G21F 9/06; C02F 2103/08; C02F 2201/002; C02F 2209/02

(57) ABSTRACT

A waste heat-driven water purification system for purifying impurity-infused water includes: an energy generation (EG) unit configured to generate energy by combustion of a fuel and oxidant and having an EG heat transfer fluid conveying a stream of a waste heat; a vapor absorption chiller (VAC) unit being driven by the stream of waste heat to produce cold water in a closed loop; and a water purification unit. The water purification unit includes: a gas hydrate-former vessel configured to form gas hydrates from the impurity-infused water and a hydrate-forming gas by cooling the impurity-infused water and the hydrate-forming gas using the cold water in the closed loop; and a gas hydrate-dissociator vessel to receive the gas hydrates and to dissociate the gas hydrates into purified water and the hydrate-forming gas by heating the gas hydrates using heat from the stream of waste heat.

### BACKGROUND

Water scarcity is a global problem and is anticipated to get worse due to climate change. Currently countries around the world tackle this problem by using energy intensive technologies such as reverse osmosis and multi-stage flash desalination. Unfortunately, these technologies, while largely adopted, have inherent drawbacks. For instance, reverse osmosis uses membranes which are expensive and cannot be used for extremely saline water. Multi-stage flash desalination is extremely energy intensive and has problems with scaling due to the salts. Hence, new technologies that would overcome these drawbacks would be welcomed.

### BRIEF SUMMARY

Disclosed is a waste heat-driven water purification system for purifying impurity-infused water, the system includes: an energy generation (EG) unit configured to generate energy by combustion of a fuel and oxidant and comprising an EG heat transfer fluid conveying a stream of a waste heat; a vapor absorption chiller (VAC) unit having a vapor absorption chilling circuit, the VAC unit being coupled to the EG unit to receive the heat transfer fluid conveying the stream of waste heat and configured to produce cold water in a closed loop with the stream of waste heat driving the vapor absorption chilling circuit; and a water purification unit. The water purification unit includes: a gas hydrate-former vessel configured to form gas hydrates from the impurity-infused water and a hydrate-forming gas by cooling the impurity-infused water and the hydrate-forming gas with a cooling element, wherein the cooling element is in heat transfer communication with the cold water in the closed loop; and a gas hydrate-dissociator vessel having a gas hydrate input configured to receive the gas hydrates formed in the gas hydrate former-vessel and to dissociate the gas hydrates into purified water and the hydrate-forming gas by heating the gas hydrates with a dissociator-heating element in heat transfer communication with the stream of waste heat.

Also disclosed is a waste heat-driven water purification method for purifying impurity-infused water includes: generating energy by combusting a fuel and oxidant in an energy generation (EG) unit comprising an EG heat transfer fluid conveying a stream of a waste heat; and producing cold water in a closed loop in a vapor absorption chiller (VAC) unit, the VAC unit receiving the stream of waste heat conveyed by the heat transfer fluid from the EG unit to drive a vapor absorption chilling circuit in the VAC unit. The method also includes forming gas hydrates from the impurity-infused water and a hydrate-forming gas using a gas hydrate-former vessel in a water purification unit by cooling the impurity-infused water and the hydrate-forming gas to form the gas hydrates using a cooling element receiving cold water from the VAC unit. The method further includes dissociating the gas hydrates received from the gas hydrate-former vessel into purified water and the hydrate-forming gas by heating the gas hydrates in a gas hydrate-dissociator vessel in the water purification unit using a dissociator-heating element receiving heat from the stream of waste heat.

### BRIEF DESCRIPTION OF THE DRAWINGS

The following descriptions should not be considered limiting in any way. With reference to the accompanying drawings, like elements are numbered alike:

FIG. 1 illustrates a simplified embodiment of a waste heat-driven water purification system;

FIG. 2 illustrates a more detailed embodiment of the waste heat-driven water purification system; and

FIG. 3 is a flow chart for a method for purifying impurity-infused using waste heat from energy generation.

### DETAILED DESCRIPTION

A detailed description of one or more embodiments of the disclosed apparatus and method presented herein by way of exemplification and not limitation with reference to the figures, in which like elements are numbered alike.

In the figures, arrows representing flow or conveyance of a fluid may include representing pipes or structures for directing the flow or conveyance. These arrows may also represent any associated components such as valves, pumps, mechanical connectors and fittings and the like needed for flowing or conveying the fluid. Similarly, arrows used to represent conveyance of electric power, signals or optical signals may represent conductors, electrical cables, fiber optic cables, electrical connectors, optical connectors, transformers, switchgear and the like needed for the fluid conveyance or operation of the equipment disclosed herein. While not explicitly discussed or illustrated, the various components of the disclosed apparatus requiring power inherently include a power supply or connection to a power source. Locations where arrows leave or enter a component can represent output ports (or connectors) or input ports (or connectors), respectively, for fluid flow or connections for electrical or optical components. Components may include remotely controlled actuators for controlling the components using a controller. The controller may receive information from sensors distributed throughout the disclosed apparatus for monitoring operation and providing feedback control when necessary. Arrows depicting heat transfer may inherently represent a working fluid or heat transfer fluid that transfers the heat.

Certain values of properties such as temperature and pressure may be presented in discussing the disclosure. These values are presented for teaching purposes only (such as for example presenting value changes or comparing values) and they are not intended to limit the disclosure.

Disclosed are embodiments of systems, apparatuses, and methods for purifying impurity-infused water by forming gas hydrates where cold water (may also be referred to as chilled water in the art) from a vapor absorption chilling unit is used to form the gas hydrates. In one or more embodiments, the cold water is at a pressure of 3 to 5 bar and a temperature of 15 to 17° C. Waste heat from an electric power generating unit (more generally referred to as an energy generation unit) is used to drive the vapor absorption chilling circuit in the vapor absorption chilling unit. The term “impurity-infused water” relates to water having a certain level of impurities that renders the water not suitable for an intended purpose. Non-limiting examples of the impurity-infused water include salt-infused water such as ocean saltwater (i.e., seawater) or brackish water and radioactive element-infused water. The discussion presented below discusses desalinating salt-infused water for teaching purposes. However, the disclosure is also applicable to purifying water infused with other types of impurities.

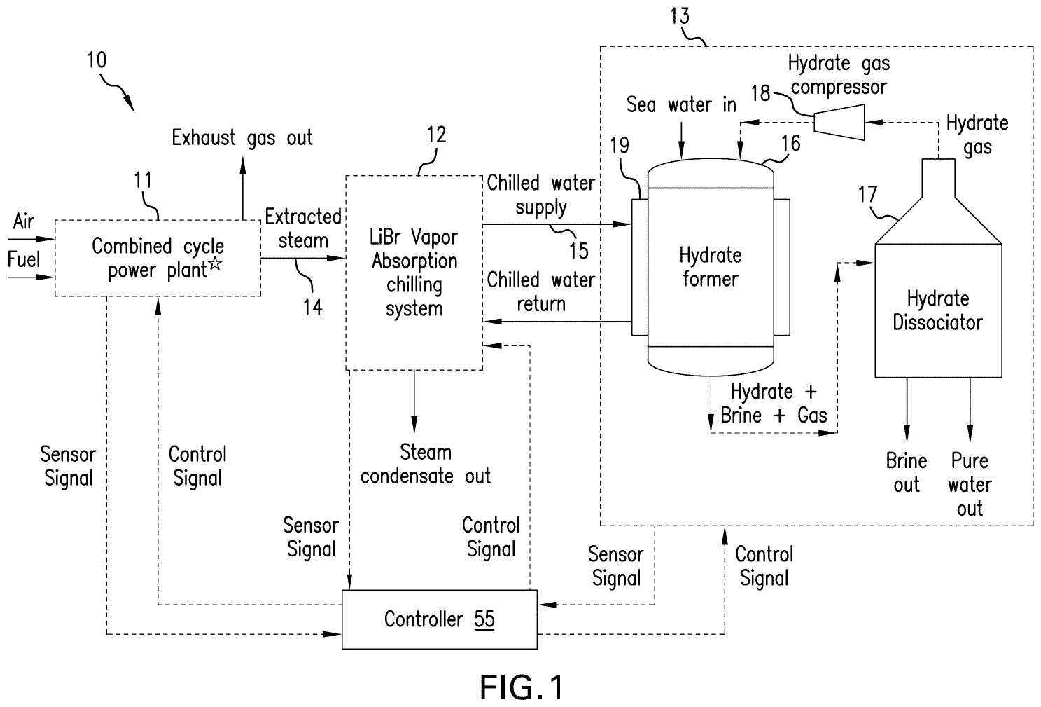

FIG. 1 illustrates a simplified embodiment of a waste heat-driven water purification (WHDWP) system 10. The WHDWP system 10 includes an electric power generation unit 11 that is configured to generate electricity by combusting fuel and an oxidant such as air and to generate steam 14 using waste heat from combusting the fuel. The steam 14 is provided to a vapor absorption chilling (VAC) unit 12 to drive a VAC process that produces cold water. The cold water flows in a cold water closed loop or circuit 15. The WHDWP system 10 also includes a water purification unit 13 to purify sea water (i.e., the impurity-infused water) by forming gas hydrates. Gas hydrates relate to a gas (i.e., a hydrate-forming gas) being enveloped by frozen purified water making it an ice-like substance generally with a crystalline form. Non-limiting examples of the hydrate-forming gas include carbon dioxide (CO2), carbon monoxide (CO), methane (CH4), and cyclopentane (CP). Other gases may also be used. The process of forming gas hydrates separates salt from the sea water leaving purified water in the gas hydrate. The separated salt forms a brine solution that is discharged. The water purification unit 13 includes a hydrate-former vessel 16 in which the gas hydrates are formed. The gas and the sea water are cooled in the hydrate-former vessel 16 by the cold water 15 to form the gas hydrates. In the embodiment of FIG. 1, the hydrate-former vessel 16 includes a heat exchanger or cooler 19 in which one side contains a flow of cold water and the other side contains a flow of the process fluids, such as the seawater and the hydrate-forming gas, to form the gas hydrates. The hydrate-forming gas and the sea water may also be cooled individually using separate coolers before they enter the hydrate-former vessel 16.

The WHDWP system 10 also includes a gas hydrate-dissociator vessel 17 configured to dissociate gas hydrates into their constituent components of purified water and the hydrate-forming gas (i.e., the gas used to form the gas hydrates). Dissociation is performed by heating the gas hydrates such that the outer shell of purified water melts. In one or more embodiments, the gas hydrates are heated to a temperature of in a range of 17 to 25° C. The purified water is then discharged from the hydrate-dissociator vessel 17 and provided to a heat exchanger (e.g., a tube/shell heat exchanger) or a tubular for supplying purified water. The dissociated hydrate-forming gas is fed to a hydrate-forming gas compressor 18 that is configured to compress the hydrate-forming gas and then discharge the compressed hydrate-forming gas to the hydrate-former vessel 16 to provide a closed circuit for the hydrate-forming gas. In an alternate embodiment, the hydrate-forming gas may be provided to the hydrate former-vessel 16 in an open circuit configuration.

As can be seen in FIG. 1, the WHDWP system 10 may include a controller 55 configured to control various components in the WHDWP system 10. Sensors distributed in the electric power generation unit 11, the VAC unit 12, and the water purification unit 13 may sense and measure various parameters such as pressure, temperature, and/or flow rate related to the operation of the WHDWP system 10. Measured values of the parameters are transmitted to the controller 55. The controller 55 implements a control algorithm based on the values of the measured parameters to output a control signal to a remote-control component such as a remotely controlled valve in order to maintain operational parameter values at a selected setpoint or within a selected range of values. Other examples of remotely controlled components include a damper, a pump, a compressor, and electrical switchgear for operating electrical equipment. Non-limiting embodiments of the control algorithm include proportional, integral, and/or derivative (PID) control algorithms, model-based algorithms, and machine learning algorithms inclusive of artificial intelligence algorithms. The control algorithm is configured to maintain operation of the WHDWP system 10 at a selected setpoint or within a desired range of values of operational parameters.

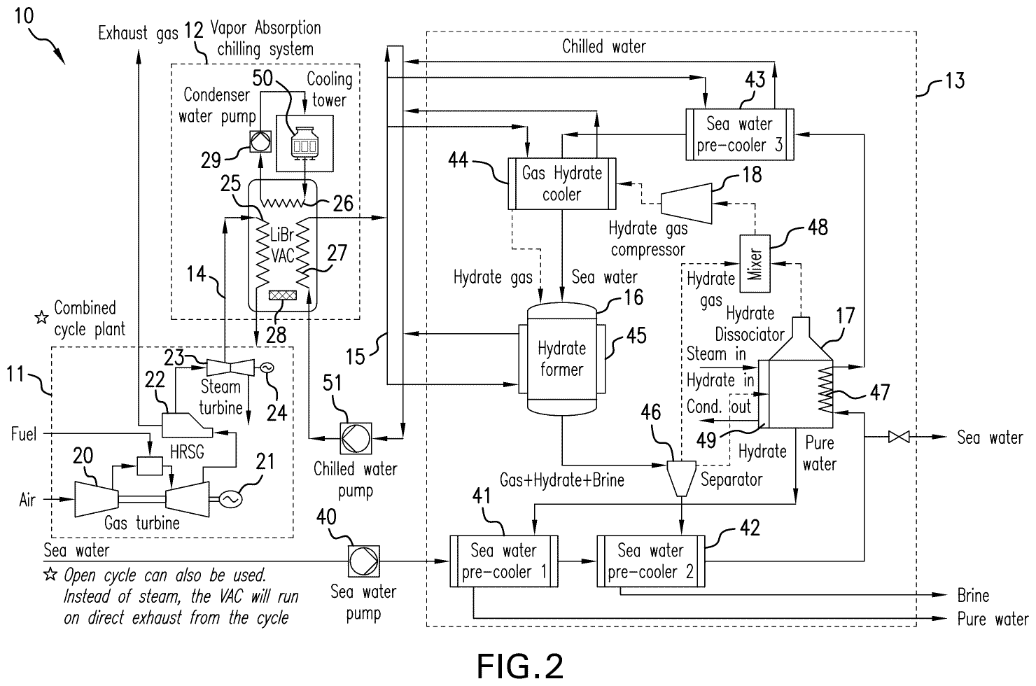

FIG. 2 illustrates a more detailed embodiment of the waste heat-driven water purification system 10. In the embodiment of FIG. 2, the electric power generation unit 11 is a combined cycle power plant that includes a gas turbine 20 coupled to a first electric generator 21. The gas turbine 20 combusts air and fuel to rotate the first electric generator 21 and thus generate electric power. Exhaust from the gas turbine 20 is directed to a heat-recovery steam generator 22 to generate a stream of steam. The generated steam is provided to a steam turbine 23 coupled to a second electric generator 24. The steam to the steam turbine 23 causes the turbine of the steam turbine 23 to rotate and thus causes the second electric generator 24 to also rotate and generate further electric power. The stream of steam 14 exits a stage of the steam turbine 23 and is provided to the VAC unit 12 for driving the VAC process. In one or more embodiments, the stream of steam 14 is saturated steam in a pressure range of 0.5 to 10 bar and relevant temperature with the steam being condensed in the VAC unit 12 and exiting the VAC unit 12 in a pressure range of 0.1-0.2 bar and a temperature range of 90 to 95° C.

It can be appreciated that in an alternative embodiment, the electric power plant 11 can be an open cycle power plant where the exhaust from the gas turbine 20 is provided directly to the VAC unit 12 for driving the VAC process. After providing heat energy to the VAC unit 12, the exhaust may then be discharged to the ambient environment in an open cycle. In that various combined cycle and open cycle power plants are known in the art, they are not discussed herein in further detail.

In the embodiment of FIG. 2, the VAC unit 12 includes a generator 25, a condenser 26, an evaporator 27, and an absorber 28. The generator 25 is coupled to the stream of waste heat 14 conveyed by the EG working fluid and is configured to heat a VAC working fluid that includes a refrigerant and an absorbent. By heating the VAC working fluid, the generator 25 evaporates the refrigerant to produce refrigerant vapor. In one or more embodiments, the VAC working fluid is a lithium-bromide solution where lithium-bromide is the absorbent and water is the refrigerant. The condenser 26 is coupled to the generator 25 and is configured to condense the refrigerant vapor using a cooling fluid to produce liquid refrigerant. In one or more embodiments, the cooling fluid is provided by a condenser water pump 29 that flows cooling water through a cooling tower 50. The evaporator 27 is coupled to the condenser 26 and is configured to receive the liquid refrigerant and to cool or chill water in the cold water closed loop 15 by evaporating the liquid refrigerant. A water pump 51 circulates the cold water in the cold water closed loop 15. In one or more embodiments, the cold water in the cold water closed loop 15 is maintained at a pressure of 3 to 5 bar and a temperature of 15 to 17° C. The absorber 28 is coupled to the evaporator 27 and configured to absorb the evaporated refrigerant with the absorbent to provide the VAC working fluid.

The water purification unit 13 is now discussed. Seawater (i.e., impurity-infused water) is pumped to the water purification unit 13 by a sea water pump 40 (more generally referred to as an impurity-infused water pump). The seawater is cooled by a first sea water pre-cooler 41. Structurally in one or more embodiments, the pre-cooler 41 and other pre-coolers discussed herein are heat exchangers in which the sea water or other fluid to be cooled flows through a tube-side and a cooling fluid such as cold water from the cold water closed loop 15 flows through a shell-side. The cooling fluid for the first sea water pre-cooler 41 is provided by the purified water discharged by the gas hydrate-dissociator vessel 17. In one or more embodiments, the purified water is at a pressure of 19 to 22 bar and a temperature of 17 to 20° C.

The sea water is further cooled by a second sea water pre-cooler 42. The cooling fluid for the second sea water pre-cooler 42 is provided by the brine solution discharged by the gas hydrate-former vessel 16. In one or more embodiments, the brine solution exiting the gas hydrate-former vessel 16 is at a pressure of 20 to 25 bar and a temperature of 13 to 16° C. In one or more embodiments, the brine solution exiting the second seawater pre-cooler 42 is at a pressure of 18 to 23 bar and a temperature of 30 to 35° C. In one or more embodiments, the seawater exiting the second seawater pre-cooler 42 is at a pressure of 22 to 27 bar and a temperature of 22 to 27° C.

The sea water exiting the second sea water pre-cooler 42 is provided to a first dissociator-heating element 47, such as a tubular coil or jacketed volume, disposed in or on the gas hydrate-dissociator vessel 17. The first heating element 47 is configured to aid in heating the gas hydrates to dissociate them. In one or more embodiments, the sea water exiting the first dissociator-heating element 47 is at a pressure of 21 to 26 bar and a temperature of 20 to 25° C.

The sea water exiting the first dissociator-heating element 47 is further cooled by a third sea water pre-cooler 43. The cooling fluid for the third sea water pre-cooler 43 is provided by the cold water in the cold water closed circuit 15. In one or more embodiments, the sea water exiting the third sea water pre-cooler 43 is at a pressure of 20 to 25 bar and a temperature of 14 to 19° C.

The sea water exiting the third sea water pre-cooler 43 is provided to the gas hydrate-former vessel 16 for forming gas hydrates using the hydrate-forming gas. The hydrate-forming vessel 16 includes a cooling element 45, such as a tubular coil disposed in the vessel 16 or a jacketed volume surrounding a perimeter of the vessel 16. The cooling element 45 includes an input path and an output path coupled to the cold water closed circuit 15. The cooling element 45 is configured to cool the contents of the hydrate-forming vessel 16 sufficiently to form the gas hydrates. The contents include the gas hydrates, extra hydrate-forming gas (i.c., excess gas not used in forming the gas hydrates), the brine solution and the seawater. In one or more embodiments, the contents of the gas hydrate-forming vessel 16 are at a pressure of 20 to 25 bar and a temperature of 13 to 16° C. Structurally, the gas hydrate-forming vessel 16 includes an input port for receiving the pre-cooled sea water, an input port for receiving compressed hydrate-forming gas, and an output port for discharging the gas hydrates, the extra hydrate-forming gas, and the brine solution.

In the embodiment of FIG. 2, the water purification unit 13 includes a separator 46 having an input port coupled to the output port of the hydrate-former vessel 16. The separator 46 is configured to separate the brine from the gas hydrate and the extra hydrate-forming gas. It may be a static vessel that provides adequate residence time to the contents so that the brine settles down at the bottom and is taken away while the gas hydrates float in the top and the extra hydrate forming gas exits at the top. Accordingly, the separator 46 includes a first output port for discharging the gas hydrates, a second output port for discharging the gas not used in forming the gas hydrates, and a third output port for discharging the brine solution. The third output port for discharging the brine solution is coupled to the second seawater pre-cooler 42 for providing the cooling fluid to the second seawater pre-cooler 42. In one or more embodiments, the extra hydrate-forming gas not used in the forming of the gas hydrates is at 20 to 25 bar and 17 to 20° C.

In the embodiment of FIG. 2, the first output port of the separator 46 is coupled to an input port of the gas hydrate-dissociator vessel 17. In the gas hydrate-dissociator vessel 17, the gas hydrates are dissociated into purified water and the hydrate-forming gas by applying heat to the gas hydrates. The heat is supplied by the first dissociator-heating element 47 and a second dissociator-heating element 49, which can be a tubular coil disposed in the gas hydrate-dissociator vessel 17 or jacketed volume surrounding a perimeter of the vessel 17. The second dissociator-heating element 49 is coupled to or in heat transfer communication with the stream of steam 14 to receive steam or heat transfer fluid for heating the gas hydrates. The steam may condense in the second dissociator-heating element 49 with the condensate being returned to the working fluid closed circuit formed by the HSRG 22 and the steam turbine 23. The gas hydrate-dissociator vessel 17 includes a first output port coupled to a cooling fluid input port of the first sea water pre-cooler 41 for flowing the purified water as the cooling fluid to the first sea water pre-cooler 41. The gas hydrate-dissociator vessel 17 also includes a second output port for discharging the dissociated hydrate-forming gas.

In the embodiment of FIG. 2, the water purification unit 13 includes a mixer 48 configured to mix the dissociated hydrate-forming gas discharged from the gas hydrate-dissociator vessel 17 and the extra hydrate-forming gas not used in forming the gas hydrates discharged from the separator 46 to form the hydrate-forming gas in total. Structurally, the mixer 48 includes a first input port coupled to the output port of the gas hydrate-dissociator vessel 17, a second input port coupled to the second output port of the separator 46, and an output port for discharging the hydrate-forming gas in total. The mixer 48 may be a static vessel which serves to equalize the pressures of the hydrates so that the output is at a single controlled pressure.

In the embodiment of FIG. 2, the water purification unit 13 includes a hydrate-forming gas compressor 18 configured to receive the hydrate-forming gas in total from the mixer 48, to compress the hydrate-forming gas in total, and to discharge compressed hydrate-forming gas in total. In one or more embodiments, the compressed hydrate-forming gas is at 23 to 28 bar and 18 to 21° C. In one or more embodiments, the hydrate-forming gas compressor 18 is a motor-driven compressor such as being driven by an electric motor.

In the embodiment of FIG. 2, the water purification unit 13 includes a hydrate-forming gas cooler 44 configured to cool (in the tube side) the compressed hydrate-forming gas discharged by the hydrate-forming gas compressor 18 to provide cooled compressed hydrate-forming gas. The hydrate-forming gas cooler 44 is coupled to the cold water closed loop 15 to receive cold water (e.g., in the shell side), which is used as a cooling fluid for the hydrate-forming gas cooler 44. In one or more embodiments, the cooled compressed hydrate-forming gas is at 21 to 26 bar and 12 to 15° C. The cooled compressed hydrate-forming gas is provided to the gas hydrate-former vessel 16. Accordingly, an output port for discharging the cooled compressed hydrate-forming forming gas from the hydrate-forming gas cooler 44 is coupled to the input port of the gas hydrate-former vessel 16 for receiving compressed hydrate-forming gas.

As can be seen on the right side of FIG. 2, excess sea water not needed for forming the gas hydrates can be discharged into the supply of sea water.

As noted above with respect to FIG. 1, the WHDWP system 10 may include the controller 55 to control various components in the WHDWP system 10. Non-limiting embodiments of parameters that may be controlled with respect to the electric power plant 11 include: pressure of fuel, air, exhaust gases, and steam; temperature of combustion air, lubrication oil, steam, and exhaust; and flow of fuel, air, and condensate water. In addition, component rotational speed, torque, vibration, damper position, and starting systems may be controlled in the electric power plant 11. Non-limiting embodiments of parameters that may be controlled with respect to the VAC unit 12 include: pressure of steam; temperature of cold water, cooling water for coolers, steam, and condensate; and flow of steam, cold water, and cooling water. In addition, an absorbent pump, a refrigerant pump, and generator level may be controlled in the VAC unit 12. Non-limiting embodiments of parameters that may be controlled with respect to the gas hydrate-former vessel 16 include: pressure within the vessel 16, sea water entering the vessel 16, and hydrate-forming gas entering the vessel 16; temperature within the vessel 16, sea water entering the vessel 16, the hydrate-forming gas, and the brine; and flow of the sea water, the hydrate-forming gas, and the brine. In addition, level control, flow timing, mechanical stirring, jacket fluid control, and drain control may be implemented with respect to the hydrate-former vessel 16. Non-limiting embodiments of parameters that may be controlled with respect to the gas hydrate-dissociator vessel 17 include: pressure and temperature within the gas hydrate-dissociator vessel 17, and flow of the gas hydrates into the gas hydrate-dissociator vessel 17, purified water discharge flow, sea water flow for heating, and discharge flow of the hydrate-forming gas. In addition, level control, flow timing, mechanical stirring, jacket fluid control, and drain control may be implemented with respect to the gas hydrate-dissociator vessel 17. Non-limiting embodiments of parameters that may be controlled with respect to the hydrate-forming gas compressor 18 include: pressure of the hydrate-forming gas, lubrication oil, and seal gas; temperature of the hydrate-forming gas, bearings. lubrication oil, and seal gas; and flow of the hydrate-forming gas, lubrication oil, and seal gas. In addition, anti-surge control, speed control, starting control, coast down control, and seal gas system control may be implemented with respect to the hydrate-forming gas compressor 18.

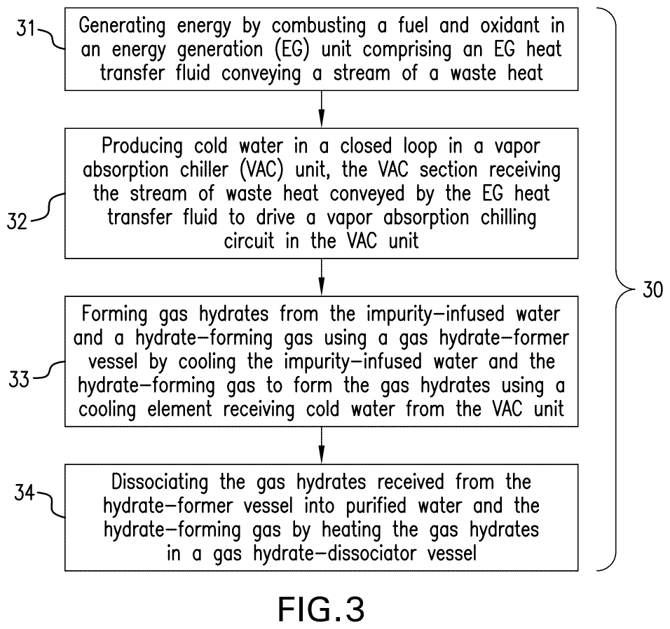

FIG. 3 is a flow chart for a method 30 for purifying impurity-infused water using waste heat from energy generation. Block 31 calls for generating energy by combusting a fuel and oxidant in an energy generation (EG) unit comprising an EG heat transfer fluid conveying a stream of a waste heat. In one or more embodiments, the energy generation unit can include a gas turbine operating in a combined cycle configuration having a heat recovery steam generator (HRSG) configured to produce steam in a range of 1 to 3.5 bar as the EG heat transfer fluid conveying the stream of a waste heat. In one or more embodiments, the EG unit includes: a gas turbine that combusts the fuel and oxidant and coupled to a first electric generator to generate first electric power as the energy; a heat recovery steam generator (HRSG) coupled to exhaust gas of the gas turbine and configured to generate steam using heat from the exhaust gas and comprising a steam output to discharge the generated steam; and a steam turbine coupled to the steam output of the HRSG and a second electric generator to generate second electric power as the energy, the steam turbine comprising a steam output to provide steam exiting the steam turbine to the VAC unit as the stream of a waste heat. Alternatively, the energy generation unit can include a gas turbine operating in an open cycle configuration. Other types of energy generation plants and cycles may also be used.

Block 32 calls for producing cold water in a closed loop in a vapor absorption chiller (VAC) unit, the VAC unit receiving the stream of waste heat conveyed by the EG heat transfer fluid to drive a vapor absorption chilling circuit in the VAC unit. The heat transfer fluid may be steam from a heat recovery steam generator or gas turbine exhaust in non-limiting embodiments. In one or more embodiments, operation of the VAC unit includes: heating a VAC working fluid having a refrigerant and an absorbent in a generator in the VAC unit to evaporate the refrigerant to produce refrigerant vapor using the stream of waste heat conveyed by the EG working fluid; condensing the refrigerant vapor in a condenser using a cooling fluid to produce liquid refrigerant; cooling water in a closed loop by evaporating the liquid refrigerant in an evaporator; and absorbing the evaporated refrigerant with the absorbent in an absorber to provide the VAC working fluid. In one or more embodiments, a water pump is coupled to the closed loop of cold water and configured to circulate the cold water at a pressure of at least 3 bar, wherein the closed loop of cold water is coupled to (i) a cooling element of the gas hydrate-former vessel, (ii) a hydrate-forming gas cooler configured to cool the hydrate-forming gas circulating towards (i.e., flowing to) the gas hydrate-former vessel, and (iii) an impurity-infused water pre-cooler configured to cool the impurity-infused water circulating towards (i.e., flowing to) the gas hydrate-former vessel.

Block 33 calls for forming gas hydrates from the impurity-infused water and a hydrate-forming gas using a gas hydrate-former vessel in a water purification unit by cooling the impurity-infused water and the hydrate-forming gas to form the gas hydrates using a cooling element receiving cold water from the VAC unit. Block 33 may also include discharging the formed gas hydrates, an impurity solution having impurities separated from the impurity-infused water, and extra hydrate-forming gas from the gas hydrate-former vessel.

Block 34 calls for dissociating the gas hydrates received from the gas hydrate-former vessel into purified water and the hydrate-forming gas by heating the gas hydrates in a gas hydrate-dissociator vessel in the water purification unit using a heating element receiving heat from the stream of waste heat. Block 34 may also include the gas hydrate-dissociator vessel discharging the purified water and the hydrate-forming gas.

The method 30 may also include heating the gas hydrates in the gas hydrate-dissociator vessel using the impurity-infused water from the supply of impurity-infused water that flows through an isolated flow path in a heating element of the gas hydrate-dissociator vessel.

The method 30 may also include separating the formed gas hydrates, the impurity solution, and the extra hydrate-forming gas into individual streams of the formed gas hydrates, the impurity solution, and the extra hydrate-forming gas using a separator in the water purification unit, the separator being configured to discharge the individual streams.

The method 30 may also include: cooling the impurity-infused water from the supply of impurity-infused water using a first heat exchanger wherein a first side of the first heat exchanger receives the purified water discharged from the gas hydrate-dissociator vessel and a second side of the second heat exchanger receives the impurity-infused water; cooling the impurity-infused water from the supply of impurity-infused water using a second heat exchanger wherein a first side of the second heat exchanger receives the impurity solution discharged by the separator and a second side of the second heat exchanger receives the impurity-infused water; cooling the impurity-infused water from the supply of impurity-infused water using a third heat exchanger wherein a first side of the third heat exchanger receives the cold water in the closed loop and a second side of the third heat exchanger receives the impurity-infused water; and cooling the hydrate-forming gas discharged from the gas hydrate-dissociator vessel and the separator using a fourth heat exchanger wherein a first side of the fourth heat exchanger receives the cold water in the closed loop and a second side of the fourth heat exchanger receives the hydrate-forming gas from the gas hydrate-dissociator vessel and the separator.

The method 30 may also include mixing a hydrate-forming gas received from the gas hydrate-dissociator vessel and an extra hydrate-forming gas received from the separator in a mixer vessel to provide hydrate-forming gas having equalized pressure.

The method 30 may also include compressing the hydrate-forming gas received from the mixer using a compressor to provide compressed hydrate-forming gas to the second side of the fourth heat exchanger.

The method 30 may also include: combusting the fuel and the oxidant using a gas turbine that is coupled to a first electric generator to generate first electric power as the energy; generating steam using a heat recovery steam generator (HRSG) that receives exhaust gas from the gas turbine; receiving the steam with a steam turbine coupled to a second electric generator for generating second electric power as the energy; and supplying steam from the HRSG to the VAC unit as the stream of a waste heat.

The disclosure herein provides several advantages. One advantage is that the purifying process is environmentally friendly as no ozone layer depleting refrigerants are used in cooling the materials used in forming the gas hydrates. Another advantage relates to the economics of the disclosure as compared to a conventional electricity-based refrigeration system for forming gas hydrates using screw compressor or scroll compressors for example. These compressor systems are typically power intensive and consume over twice as much energy as compared to the present disclosure. Hence, the present disclosure is especially attractive in expensive power cost areas.

Embodiment 1: A waste heat-driven water purification system for purifying impurity-infused water, the system including an energy generation (EG) unit configured to generate energy by combustion of a fuel and oxidant and comprising an EG heat transfer fluid conveying a stream of a waste heat; a vapor absorption chiller (VAC) unit comprising a vapor absorption chilling circuit, the VAC unit being coupled to the EG unit to receive the heat transfer fluid conveying the stream of waste heat and configured to produce cold water in a closed loop with the stream of waste heat driving the vapor absorption chilling circuit; and a water purification unit comprising: a gas hydrate-former vessel configured to form gas hydrates from the impurity-infused water and a hydrate-forming gas by cooling the impurity-infused water and the hydrate-forming gas with a cooling element, wherein the cooling element is in heat transfer communication with the cold water in the closed loop; and a gas hydrate-dissociator vessel comprising a gas hydrate input configured to receive the gas hydrates formed in the gas hydrate former-vessel and to dissociate the gas hydrates into purified water and the hydrate-forming gas by heating the gas hydrates with a dissociator-heating element in heat transfer communication with the stream of waste heat.

Embodiment 2: The waste heat-driven water purification system as in any prior embodiment, wherein the vapor absorption chilling circuit comprises a generator coupled to the stream of waste heat conveyed by the EG heat transfer fluid, the generator being configured to heat a VAC working fluid comprising a refrigerant and an absorbent to evaporate the refrigerant to produce refrigerant vapor; a condenser coupled to the generator, the condenser being configured to condense the refrigerant vapor using a cooling fluid to produce liquid refrigerant; an evaporator coupled to the condenser, the evaporator being configured to receive the liquid refrigerant and to cool water in the closed loop by evaporating the liquid refrigerant to provide evaporated refrigerant; and an absorber coupled to the evaporator, the absorber being configured to absorb the evaporated refrigerant with the absorbent to provide the VAC working fluid.

Embodiment 3: The waste heat-driven water purification system as in any prior embodiment, wherein the EG unit is implemented as a combined cycle power plant having a heat recovery steam generator (HRSG) configured to produce steam at a pressure in a range of 0.5 to 10 bar as the EG heat transfer fluid conveying the stream of a waste heat.

Embodiment 4: The waste heat-driven water purification system as in any prior embodiment, further comprising a separator configured to receive the gas hydrates, an impurity solution, and extra hydrate-forming gas not used in forming the gas hydrates from the gas hydrate-former vessel and to separate those received components into individual streams of the formed gas hydrates, the impurity solution, and the extra hydrate-forming gas not used in forming the gas hydrates, the separator comprising a gas hydrate output for discharging the formed gas hydrates, an impurity output for discharging the impurity solution, and an extra hydrate-forming gas output for discharging the extra hydrate-forming gas not used in forming the gas hydrates.

Embodiment 5: The waste heat-driven water purification system as in any prior embodiment, wherein the water purification unit further comprises a first heat exchanger having a first side that receives the purified water discharged from the gas hydrate-dissociator vessel and a second side that receives the impurity-infused water from a supply of impurity infused water; a second heat exchanger having a first side that receives the impurity solution discharged by the separator and a second side that receives the impurity-infused water from the supply of impurity infused water; a third heat exchanger having a first side that receives the cold water from the closed loop and a second side that receives the impurity-infused water from the supply of impurity infused water; and a fourth heat exchanger having a first side that receives the cold water from the closed loop and a second side that receives the hydrate-forming gas from the gas hydrate-dissociator vessel.

Embodiment 6: The waste heat-driven water purification system as in any prior embodiment, further comprising a mixer vessel having a first hydrate-forming gas input coupled to the hydrate-forming gas output of the gas hydrate dissociator vessel and a second hydrate-forming gas input coupled to the extra hydrate-forming gas output of the separator, the mixer vessel comprising a volume to mix and equalize pressure of the two inputs of hydrate-forming gas, the mixer vessel comprising an output discharging the hydrate-forming gas from the volume.

Embodiment 7: The waste heat-driven water purification system as in any prior embodiment, further comprising a hydrate-forming gas compressor configured to compress hydrate-forming gas, the hydrate-forming gas compressor having a hydrate-forming gas input coupled to the output of the mixer vessel and an output coupled to the second side of the fourth heat exchanger.

Embodiment 8: The waste heat-driven water purification system as in any prior embodiment, wherein the impurity-infused water comprises a salt-infused water and/or a radioactive particle-infused water.

Embodiment 9: The waste heat-driven water purification system as in any prior embodiment, further comprising a water pump coupled to the closed loop of cold water and configured to circulate the cold water at a pressure of at least 0.5 bar, wherein the closed loop of cold water is coupled to the cooling element of the gas hydrate-former vessel, a hydrate-forming gas cooler configured to cool the hydrate-forming gas circulating towards the gas hydrate-former vessel, and an impurity-infused water pre-cooler configured to cool the impurity-infused water circulating towards the gas hydrate-former vessel.

Embodiment 10: The waste heat-driven water purification system as in any prior embodiment, wherein the refrigerant comprises water and the absorbent comprises lithium-bromide.

Embodiment 11: A waste heat-driven water purification method for purifying impurity-infused water, the method comprising generating energy by combusting a fuel and oxidant in an energy generation (EG) unit comprising an EG heat transfer fluid conveying a stream of a waste heat; producing cold water in a closed loop in a vapor absorption chiller (VAC) unit, the VAC unit receiving the stream of waste heat conveyed by the heat transfer fluid from the EG unit to drive a vapor absorption chilling circuit in the VAC unit; forming gas hydrates from the impurity-infused water and a hydrate-forming gas using a gas hydrate-former vessel in a water purification unit by cooling the impurity-infused water and the hydrate-forming gas to form the gas hydrates using a cooling element receiving cold water from the VAC unit; and dissociating the gas hydrates received from the gas hydrate-former vessel into purified water and the hydrate-forming gas by heating the gas hydrates in a gas hydrate-dissociator vessel in the water purification unit using a dissociator-heating element receiving heat from the stream of waste heat.

Embodiment 12: The waste heat-driven water purification method as in any prior embodiment, further comprising heating a VAC working fluid comprising a refrigerant and an absorbent in a generator in the VAC unit to evaporate the refrigerant to produce refrigerant vapor using the stream of waste heat conveyed by the EG heat transfer fluid; condensing the refrigerant vapor in a condenser using a cooling fluid to produce liquid refrigerant; cooling water in a closed circuit by evaporating the liquid refrigerant in an evaporator to provide evaporated refrigerant; and absorbing the evaporated refrigerant with the absorbent in an absorber to provide the VAC working fluid.

Embodiment 13: The waste heat-driven water purification method as in any prior embodiment, further comprising producing steam at a pressure in a range of 0.5 to 10 bar as the EG heat transfer fluid conveying the stream of a waste heat from the EG unit, wherein the EG unit is implemented as a combined cycle power plant having a heat recovery steam generator (HRSG) configured to produce the steam.

Embodiment 14: The waste heat-driven water purification method as in any prior embodiment, further comprising separating the gas hydrates, the impurity solution, and the extra hydrate-forming gas not used in forming the gas hydrates received from the gas hydrate-forming vessel into individual streams of the gas hydrates, the impurity solution, and the extra hydrate-forming gas not used in forming the gas hydrates using a separator, the separator being configured to discharge the individual streams.

Embodiment 15: The waste heat-driven water purification method as in any prior embodiment, further comprising cooling the impurity-infused water from a supply of impurity-infused water using a first heat exchanger wherein a first side of the first heat exchanger receives the purified water discharged from the gas hydrate-dissociator vessel and a second side of the first heat exchanger receives the impurity-infused water; cooling the impurity-infused water from the supply of impurity-infused water using a second heat exchanger wherein a first side of the second heat exchanger receives the impurity solution discharged by the separator and a second side of the second heat exchanger receives the impurity-infused water; cooling the impurity-infused water from the supply of impurity-infused water using a third heat exchanger wherein a first side of the third heat exchanger receives the cooled water in the closed loop and a second side of the third heat exchanger receives the impurity-infused water; and cooling the hydrate-forming gas discharged from the gas hydrate-dissociator vessel and the separator using a fourth heat exchanger wherein a first side of the fourth heat exchanger receives the cold water in the closed loop and a second side of the fourth heat exchanger receives the hydrate-forming gas from the gas hydrate-dissociator vessel and the separator.

Embodiment 16: The waste heat-driven water purification method as in any prior embodiment, further comprising by mixing a hydrate-forming gas received from the hydrate-dissociator vessel and the extra hydrate-forming gas received from the separator in a mixer vessel to provide hydrate-forming gas having equalized pressure.

Embodiment 17: The waste heat-driven water purification method as in any prior embodiment, further comprising compressing the hydrate-forming gas having equalized pressure using a compressor to provide compressed hydrate-forming gas to the second side of the fourth heat exchanger.

Embodiment 18: The waste heat-driven water purification method as in any prior embodiment, wherein the impurity-infused water comprises a salt-infused water and/or a radioactive particle-infused water.

Embodiment 19: The waste heat-driven water purification method as in any prior embodiment, further comprising by circulating the cold water in the closed loop of cold water at a pressure of at least 0.5 bar using a water pump coupled to the closed loop of cold water, wherein the closed loop of cold water is coupled to a cooling element of the gas hydrate-former vessel, a hydrate-forming gas cooler configured to cool the hydrate-forming gas circulating towards the gas hydrate-former vessel, and an impurity-infused water pre-cooler configured to cool the impurity-infused water circulating towards the gas hydrate-former vessel.

Embodiment 20: The waste heat-driven water purification method as in any prior embodiment, wherein the refrigerant comprises water and the absorbent comprises lithium-bromide.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates to one or more structural limitations of a device that are required for the device to perform the function or operation for which the device is configured. The limitations may be known in the art for a specific item, but not known in the context of or application to the invention as a whole. The limitations may be inclusive of circuit modules and software known to perform a specific function. The term “coupled” relates to being coupled directly or indirectly using an intermediate device. The terms “first” and “second” and like are used to distinguish terms and not to denote a particular order.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed:

1. A waste heat-driven water purification system for purifying impurity-infused water, the system comprising:
an energy generation (EG) unit configured to generate energy by combustion of a fuel and oxidant and comprising an EG heat transfer fluid conveying a stream of a waste heat;
a vapor absorption chiller (VAC) unit comprising a vapor absorption chilling circuit, the VAC unit being coupled to the EG unit to receive the heat transfer fluid conveying the stream of waste heat and configured to produce cold water in a closed loop with the stream of waste heat driving the vapor absorption chilling circuit; and
a water purification unit comprising:
a gas hydrate-former vessel configured to form gas hydrates from the impurity-infused water and a hydrate-forming gas by cooling the impurity-infused water and the hydrate-forming gas with a cooling element, wherein the cooling element is in heat transfer communication with the cold water in the closed loop; and
a gas hydrate-dissociator vessel comprising a gas hydrate input configured to receive the gas hydrates formed in the gas hydrate former-vessel and to dissociate the gas hydrates into purified water and the hydrate-forming gas by heating the gas hydrates with a dissociator-heating element in heat transfer communication with the stream of waste heat.

2. The waste heat-driven water purification system according to claim 1, wherein the vapor absorption chilling circuit comprises:
a generator coupled to the stream of waste heat conveyed by the EG heat transfer fluid, the generator being configured to heat a VAC working fluid comprising a refrigerant and an absorbent to evaporate the refrigerant to produce refrigerant vapor;
a condenser coupled to the generator, the condenser being configured to condense the refrigerant vapor using a cooling fluid to produce liquid refrigerant;
an evaporator coupled to the condenser, the evaporator being configured to receive the liquid refrigerant and to cool water in the closed loop by evaporating the liquid refrigerant to provide evaporated refrigerant; and
an absorber coupled to the evaporator, the absorber being configured to absorb the evaporated refrigerant with the absorbent to provide the VAC working fluid.

3. The waste heat-driven water purification system according to claim 1, wherein the EG unit is implemented as a combined cycle power plant having a heat recovery steam generator (HRSG) configured to produce steam at a pressure in a range of 0.5 to 10 bar as the EG heat transfer fluid conveying the stream of a waste heat.

4. The waste heat-driven water purification system according to claim 1, further comprising a separator configured to receive the gas hydrates, an impurity solution, and extra hydrate-forming gas not used in forming the gas hydrates from the gas hydrate-former vessel and to separate those received components into individual streams of the formed gas hydrates, the impurity solution, and the extra hydrate-forming gas not used in forming the gas hydrates, the separator comprising a gas hydrate output for discharging the formed gas hydrates, an impurity output for discharging the impurity solution, and an extra hydrate-forming gas output for discharging the extra hydrate-forming gas not used in forming the gas hydrates.

5. The waste heat-driven water purification system according to claim 4, wherein the water purification unit further comprises:
a first heat exchanger having a first side that receives the purified water discharged from the gas hydrate-dissociator vessel and a second side that receives the impurity-infused water from a supply of impurity infused water;
a second heat exchanger having a first side that receives the impurity solution discharged by the separator and a second side that receives the impurity-infused water from the supply of impurity infused water;
a third heat exchanger having a first side that receives the cold water from the closed loop and a second side that receives the impurity-infused water from the supply of impurity infused water; and
a fourth heat exchanger having a first side that receives the cold water from the closed loop and a second side that receives the hydrate-forming gas from the gas hydrate-dissociator vessel.

6. The waste heat-driven water purification system according to claim 5, further comprising a mixer vessel having a first hydrate-forming gas input coupled to the hydrate-forming gas output of the gas hydrate dissociator vessel and a second hydrate-forming gas input coupled to the extra hydrate-forming gas output of the separator, the mixer vessel comprising a volume to mix and equalize pressure of the two inputs of hydrate-forming gas, the mixer vessel comprising an output discharging the hydrate-forming gas from the volume.

7. The waste heat-driven water purification system according to claim 6, further comprising a hydrate-forming gas compressor configured to compress hydrate-forming gas, the hydrate-forming gas compressor having a hydrate-forming gas input coupled to the output of the mixer vessel and an output coupled to the second side of the fourth heat exchanger.

8. The waste heat-driven water purification system according to claim 1, wherein the impurity-infused water comprises a salt-infused water and/or a radioactive particle-infused water.

9. The waste heat-driven water purification system according to claim 1, further comprising a water pump coupled to the closed loop of cold water and configured to circulate the cold water at a pressure of at least 0.5 bar, wherein the closed loop of cold water is coupled to the cooling element of the gas hydrate-former vessel, a hydrate-forming gas cooler configured to cool the hydrate-forming gas circulating towards the gas hydrate-former vessel, and an impurity-infused water pre-cooler configured to cool the impurity-infused water circulating towards the gas hydrate-former vessel.

10. The waste heat-driven water purification system according to claim 2, wherein the refrigerant comprises water and the absorbent comprises lithium-bromide.

11. A waste heat-driven water purification method for purifying impurity-infused water, the method comprising:
generating energy by combusting a fuel and oxidant in an energy generation (EG) unit comprising an EG heat transfer fluid conveying a stream of a waste heat;
producing cold water in a closed loop in a vapor absorption chiller (VAC) unit, the VAC unit receiving the stream of waste heat conveyed by the heat transfer fluid from the EG unit to drive a vapor absorption chilling circuit in the VAC unit;
forming gas hydrates from the impurity-infused water and a hydrate-forming gas using a gas hydrate-former vessel in a water purification unit by cooling the impurity-infused water and the hydrate-forming gas to form the gas hydrates using a cooling element receiving cold water from the VAC unit; and
dissociating the gas hydrates received from the gas hydrate-former vessel into purified water and the hydrate-forming gas by heating the gas hydrates in a gas hydrate-dissociator vessel in the water purification unit using a dissociator-heating element receiving heat from the stream of waste heat.

12. The waste heat-driven water purification method according to claim 11, further comprising:
heating a VAC working fluid comprising a refrigerant and an absorbent in a generator in the VAC unit to evaporate the refrigerant to produce refrigerant vapor using the stream of waste heat conveyed by the EG heat transfer fluid;
condensing the refrigerant vapor in a condenser using a cooling fluid to produce liquid refrigerant;
cooling water in a closed circuit by evaporating the liquid refrigerant in an evaporator to provide evaporated refrigerant; and
absorbing the evaporated refrigerant with the absorbent in an absorber to provide the VAC working fluid.

13. The waste heat-driven water purification method according to claim 11, further comprising producing steam at a pressure in a range of 0.5 to 10 bar as the EG heat transfer fluid conveying the stream of a waste heat from the EG unit, wherein the EG unit is implemented as a combined cycle power plant having a heat recovery steam generator (HRSG) configured to produce the steam.

14. The waste heat-driven water purification method according to claim 11, further comprising separating the gas hydrates, the impurity solution, and the extra hydrate-forming gas not used in forming the gas hydrates received from the gas hydrate-forming vessel into individual streams of the gas hydrates, the impurity solution, and the extra hydrate-forming gas not used in forming the gas hydrates using a separator, the separator being configured to discharge the individual streams.

15. The waste heat-driven water purification method according to claim 14, further comprising:
cooling the impurity-infused water from a supply of impurity-infused water using a first heat exchanger wherein a first side of the first heat exchanger receives the purified water discharged from the gas hydrate-dissociator vessel and a second side of the first heat exchanger receives the impurity-infused water;
cooling the impurity-infused water from the supply of impurity-infused water using a second heat exchanger wherein a first side of the second heat exchanger receives the impurity solution discharged by the separator and a second side of the second heat exchanger receives the impurity-infused water;
cooling the impurity-infused water from the supply of impurity-infused water using a third heat exchanger wherein a first side of the third heat exchanger receives the cooled water in the closed loop and a second side of the third heat exchanger receives the impurity-infused water; and
cooling the hydrate-forming gas discharged from the gas hydrate-dissociator vessel and the separator using a fourth heat exchanger wherein a first side of the fourth heat exchanger receives the cold water in the closed loop and a second side of the fourth heat exchanger receives the hydrate-forming gas from the gas hydrate-dissociator vessel and the separator.

16. The waste heat-driven water purification method according to claim 15, further comprising by mixing a hydrate-forming gas received from the hydrate-dissociator vessel and the extra hydrate-forming gas received from the separator in a mixer vessel to provide hydrate-forming gas having equalized pressure.

17. The waste heat-driven water purification method according to claim 16, further comprising compressing the hydrate-forming gas having equalized pressure using a compressor to provide compressed hydrate-forming gas to the second side of the fourth heat exchanger.

18. The waste heat-driven water purification method according to claim 11, wherein the impurity-infused water comprises a salt-infused water and/or a radioactive particle-infused water.

19. The waste heat-driven water purification method according to claim 11, further comprising by circulating the cold water in the closed loop of cold water at a pressure of at least 0.5 bar using a water pump coupled to the closed loop of cold water, wherein the closed loop of cold water is coupled to a cooling element of the gas hydrate-former vessel, a hydrate-forming gas cooler configured to cool the hydrate-forming gas circulating towards the gas hydrate-former vessel, and an impurity-infused water pre-cooler configured to cool the impurity-infused water circulating towards the gas hydrate-former vessel.

20. The waste heat-driven water purification method according to claim 12, wherein the refrigerant comprises water and the absorbent comprises lithium-bromide.
